(19) United States
(12) Patent Application Publication
(10) Pub. No.: US 2021/0400357 A1
(43) Pub. Date: Dec. 23, 2021

(54) Method of High-Definition Video Transmission

(71) Applicant: YUAN High-Tech Development Co., Ltd., Taipei (TW)

(72) Inventor: Hueng-Pei Lin, New Taipei City (TW)

(21) Appl. No.: 16/909,054

(22) Filed: Jun. 23, 2020

(51) Int. Cl. H04N 21/63; G06F 13/12; H04N 7/12; H04L 29/06

(52) U.S. Cl. CPC H04N 21/632; G06F 13/128; H04L 65/1069; H04L 65/607; H04N 7/12

(57) ABSTRACT

A method is provided for transmitting high-definition video. A device used electrically connects to graphics processing units (GPU) and a network switch. Each GPU comprises a circuit board, video transmission interfaces, Internet protocol interfaces, and a mobile peripheral-component-interface-express module (M×M) video chip module. The M×M video chip module is designed as industrial standard M×M. Only a circuit board is required for video transmission. Based on specifications of software defined video over ethernet (SDVoE), video signals of the second version of high definition multimedia interface are transformed onto an IP network with no time delay and no compression while fabricating a video card of SDVoE output. GPUs can be replaced through generations no matter how M×M is changed. By replacing the M×M video chip module without redesigning the whole video card, resources waste is effectively decreased with energy saving and carbon reduction.

### TECHNICAL FIELD OF THE INVENTION

The present invention relates to video transmission; more particularly, to conforming to industrial standard specifications of mobile peripheral component interface express (PCI-E) module (M×M) and a technology of software defined video over ethernet (SDVoE) to transform video signals of the second version of high definition multimedia interface (HDMI 2.0) onto an Internet protocol (IP) network to fabricate a video card of SDVoE output, where graphics processing units (GPU) are replaced through generations; and only an M×M video chip module on a circuit board is replaced without redesigning the whole video card.

### DESCRIPTION OF THE RELATED ARTS

With more and more rapid dissemination of information, people will ask for higher image quality and processing speed. For example, fields related with game entertainments, digital monitors, retail stores, public transports and medical imaging require image processing programs with high performance and long and stable operations.

On the basis of the existing market of video card, the video cards are all for HDMI displayport output. Conventional video chip uses existing GPU-level specifications, which follows different specifications of GPU video card for changed processing levels of integrated circuit (IC). But, following future improvements on imaging technology, video ICs will have to be updated. As a result, IC boards have to be redesigned all the time, which creates a vicious cycle of resource waste. Hence, the prior arts do not fulfill all users' requests on actual use.

### SUMMARY OF THE INVENTION

The main purpose of the present invention is to conform to industrial standard specifications of M×M and an SDVoE technology to transform HDMI 2.0 video signals onto an IP network to fabricate a video card of SDVoE output, where GPUs are replaced through generations without changing M×M specifications; and, by replacing an M×M video chip module without redesigning the whole video card all the time, resource waste is effectively decreased together with energy saving and carbon reduction.

To achieve the above purposes, the present invention is a method of high-definition (HD) video transmission, comprising steps of: (a) first step: electrically connecting a network switch to a first GPU and a second GPU among a plurality of GPUs, where each of the GPUs comprises a circuit board; a plurality of video transmission interfaces, the video transmission interfaces separately electrically connecting to the circuit board; a plurality of IP interfaces, the IP interfaces separately electrically connecting to the circuit board; and an M×M video chip module, the M×M video chip module being replaceable and plugged in the circuit board and electrically connecting to the circuit board, the M×M video chip module electrically connecting to the video transmission interfaces and the IP interfaces through the circuit board, where the M×M video chip module has an input/output (I/O) bus and a PCI-E bus; (b) second step: connecting the first GPU to a video source terminal and connecting the second GPU to a video receiving terminal; and (c) third step: obtaining the M×M video chip module conforming to specifications of software defined video over ethernet (SDVoE); on receiving HD video signals from the video source terminal through a first video transmission interface among the video transmission interfaces by the first GPU among the GPUs, transforming the HD video signals into IP signals in a way of no delay and no compression to be outputted to the network switch through a first IP interface among the IP interfaces; and, on receiving the IP signals from the network switch through a second IP interface among the IP interfaces by the second GPU among the GPUs, transforming the IP signals back to the HD video signals in a way of no delay and no compression to be outputted to the video receiving terminal through a second video transmission interface among the video transmission interfaces.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the structural view showing the device used; and

FIG. 3 is the view showing the state-of-use.

### DESCRIPTION OF THE PREFERRED EMBODIMENT

The following description of the preferred embodiment is provided to understand the features and the structures of the present invention.

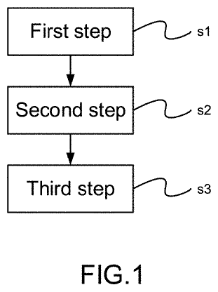

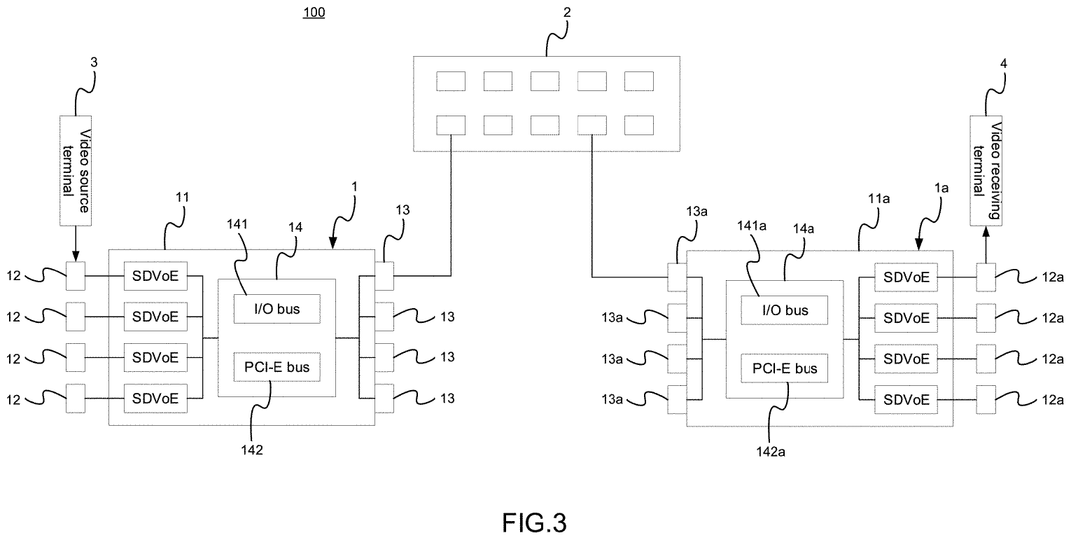

Please refer to FIG. 1 to FIG. 3, which are a flow view showing a preferred embodiment according to the present invention; a structural view showing a device used; and a view showing a state-of-use. As shown in the figures, the present invention is a method of high-definition (HD) video transmission, suitable for the application of a device 100 for HD video transmission. The device 100 electrically connects to a plurality of video processing units (GPU) 1,1a and a network switch 2. Each of the GPUs 1,1a comprises a circuit board 11,11a, a plurality of video transmission interfaces 12,12a, a plurality of internet protocol (IP) interfaces 13,13a, and a mobile peripheral component interface express' (PCI-E) module (M×M) video chip module 14,14a. On using, the present invention comprises the following steps:

(a) First step s1: The network switch 2 electrically connects to a first GPU 1 and a second GPU 1a among a plurality of GPUs 1,1a, . . . (to a certain number). Therein, in each of the GPUs 1,1a, the circuit board 11,11a is provided with an M×M slot (not shown in the figure); the video transmission interfaces 12,12a separately electrically connect to the circuit board 11,11a; the IP interfaces 13,13a separately electrically connect to the circuit board 11,11a; the M×M video chip module 14,14a is replaceable and plugged in the M×M slot, electrically connects to the circuit board 11,11a, and electrically connects to the video transmission interfaces 12,12a and the IP interfaces 13,13a through the circuit board 11,11a; and the M×M video chip module 14,14a is provided with an input/output (I/O) bus 141,141a and a PCI-E bus 142,142a.

(b) Second step s2: The first GPU 1 connects to a video source terminal 3 and the second GPU 1a connects to a video receiving terminal 4.

(c) Third step s3: The M×M video chip module 14,14a uses specifications of software defined video over ethernet (SDVoE). On receiving from the video source terminal 3 through a first video transmission interface 12 among the video transmission interfaces 12,12a by the first GPU 1 among the GPUs 1,1a, . . . , HD video signals are transformed into IP signals in a way of no delay and no compression to be outputted to the network switch 2 through the first IP interface 13 among the IP interfaces 13,13a. On receiving from the network switch 2 through a second IP interface 13a among the IP interfaces 13,13a by the second GPU 1a among the GPUs 1,1a, . . . , the IP signals are transformed back to the HD video signals in a way of no delay and no compression to be outputted to the video receiving terminal 4 through the second video transmission interface 12a among the video transmission interfaces 12,12a. Thus, a novel method of HD video transmission is obtained.

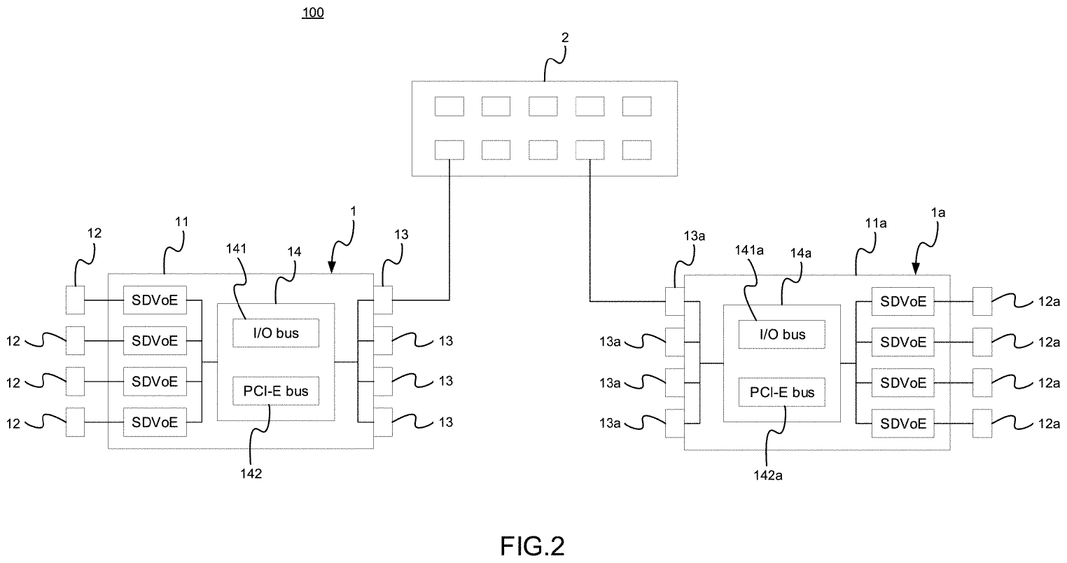

In a state-of-use, the above steps are processed by the HD video transmission device 100. The HD video transmission device 100 comprises a network switch 2 (e.g. switch hub) and a plurality of GPUs 1,1a. Therein, a GPU 1 is used as a first GPU 1 and another GPU 1a is used as a second GPU 1a. It should be noticed that, although only two GPUs 1,1a are shown in FIG. 2, the present invention is not limited because the HD video transmission device 100 can be expanded to have more GPUs in practices.

Architecturally, the GPUs 1,1a electrically connect to the network switch 2. As an example, the GPUs 1,1a connect to the network switch 2 through a cable line or a fiber line conforming to CAT-6 specifications or CAT-7 specifications; and the IP interfaces 13,13a support connections of at most 10 gigabyte ethernet (GbE). Therein, the first GPU 1 connects to the video source terminal 3 and the second GPU 1a connects to the video receiving terminal 4. In the state-of-use, the video source terminal 3 obtains HD video signals, which are video signals confirming to HDMI 2.0 specifications for 4K resolution and 60P frame rate; the video transmission interfaces 12,12a conform to HDMI 2.0 specifications; and the I/O bus in the M×M video chip module 14,14a conforms to specifications of HDMI 2.0×4. It should be noticed that, although only four instances consisting of the video transmission interfaces 12,12a and the IP interfaces 13,13a are shown in FIG. 1, the present invention is not limited because the HD video transmission device 100 can be expanded to have more video transmission interfaces and IP interfaces in practices.

On using the present invention, as an example, a first GPU 1 receives HD video signals from a video source terminal 3 (e.g. computer, cell phone, etc.) through a video transmission interface 12; an M×M video chip module 14 uses specifications of SDVoE to, in a way of no delay and no compression, transform HD video signals into IP signals to be outputted to a network switch 2 through an IP interfaces 13; a network switch 2 transmits the IP signals to a second GPU 1a; and, after the IP signals are received from the network switch 2 through another IP interface 13a, another M×M video chip module 14a uses SDVoE specifications to, in a way of no delay and no compression, transform the IP signals back to the HD video signals to be outputted to a video receiving terminal 4 (e.g. monitor) through another video transmission interface 12a for displaying.

Thus, the present invention designs an M×M video chip module based on industrial specifications of standard M×M. Only a circuit board is required to be plugged in for transmitting HD video. According to internal SDVoE specifications, HDMI 2.0 video signals are transformed onto an IP network (10 gigabits) in a way of no time delay and no compression while fabricating a video display card of SDVoE output. Hence, GPUs are replaced through generations with M×M specifications unchanged. By replacing the M×M video chip module without redesigning the whole video board all the time, resource waste is effectively decreased together with energy saving and carbon reduction.

To sum up, the present invention is a method of HD video transmission, where, based on industrial standard M×M specifications and SDVoE technology, HDMI 2.0 video signals are transformed onto IP network for fabricating a video card of SDVoE output; thus, GPUs are replaced through generations without changing M×M specifications; and, by replacing an M×M video chip module on a circuit board without redesigning the whole video board all the time, resource waste is effectively decreased together with energy saving and carbon reduction.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of high-definition (HD) video transmission, comprising steps of:
electrically connecting a network switch to a first graphics processing unit (GPU) and a second GPU among a plurality of GPUs;
connecting said first GPU to a video source terminal and connecting said second GPU to a video receiving terminal; and
obtaining a mobile peripheral-component-interface-express (PCI-E) module (M×M) video chip module conforming to specifications of software defined video over ethernet (SDVoE) in each of said GPUs; on receiving HD video signals from said video source terminal through a first video transmission interface among a plurality of video transmission interfaces by said first GPU among said GPUs, transforming said HD video signals into a plurality of Internet protocol (IP) signals in a way of no delay and no compression to be outputted to a network switch through a first IP interface among a plurality of IP interfaces; and, on receiving said IP signals from said network switch through a second IP interface among said IP interfaces by said second GPU among said GPUs, transforming said IP signals back to said HD video signals in a way of no delay and no compression to be outputted to said video receiving terminal through a second video transmission interface among said video transmission interfaces.

2. The method according to claim 1,
wherein said network switch is a switch hub.

3. The method according to claim 1,
wherein each of said GPUs connects to said network switch through a line selected from a group consisting of a cable line and a fiber line; and said line conforms to specifications selected from a group consisting of CAT-6 specifications and CAT-7 specifications.

4. The method according to claim 1,
wherein each of said GPUs comprises a circuit board, said video transmission interfaces, said IP interfaces, and said M×M video chip module; said video transmission interfaces separately electrically connect to said circuit board; said IP interfaces separately electrically connect to said circuit board; said M×M video chip module is replaceable and plugged in said circuit board and electrically connects to said circuit board; and said M×M video chip module electrically connects to said video transmission interfaces and said IP interfaces through said circuit board.

5. The method according to claim 4,
wherein said circuit board has an M×M slot; and
wherein said M×M video chip module is replaceable and plugged in said M×M slot.

6. The method according to claim 1,
wherein said IP interfaces obtain connections of at most 10-gigabyte ethernet.

7. The method according to claim 1,
wherein said video source terminal is selected from a group consisting of a computer and a cell phone.

8. The method according to claim 1,
wherein said video receiving terminal is a monitor.

9. The method according to claim 1,
wherein said M×M video chip module has an input/output (I/O) bus and a PCI-E bus;

10. The method according to claim 9,
wherein said I/O bus conforms to specifications of version 2.0 of HD multimedia interface (HDMI) (HDMI 2.0)×N, and N is a positive integer.

11. The method according to claim 1,
wherein said HD video signals are video signals conforming to specifications of an interface selected from a group consisting of an HDMI 2.0 interface, a digital video interface, a serial digital interface, and a digital video interface.

12. The method according to claim 1,
wherein said HD video signals are 4K-resolution video signals confirming to HDMI 2.0 specifications.

13. The method according to claim 1,
wherein each of said video transmission interfaces is selected from a group consisting of an HDMI interface, a digital video interface, a serial digital interface, and a digital video interface.
